(19) United States
(12) Patent Application Publication
(10) Pub. No.: US 2023/0401452 A1
(43) Pub. Date: Dec. 14, 2023

(54) SYSTEMS AND METHODS FOR WEIGHT-AGNOSTIC FEDERATED NEURAL ARCHITECTURE SEARCH

(71) Applicant: Arizona Board of Regents on Behalf of Arizona State University, Tempe, AZ (US)

(72) Inventors: Rida Bazzi, Scottsdale, AZ (US); Om Thakkar, San Jose, AZ (US)

(21) Appl. No.: 18/335,080

(22) Filed: Jun. 14, 2023

Related U.S. Application Data
(60) Provisional application No. 63/352,056, filed on Jun. 14, 2022.

(51) Int. Cl. G06N 3/0985; G06N 3/098

(52) U.S. Cl. CPC G06N 3/0985; G06N 3/098

(57) ABSTRACT

Systems and methods herein train weight-agnostic networks in a federated learning setting with orthogonal data distribution. Unlike traditional networks, weight-agnostic networks have a small size and can be trained using neural architecture search. The methods and systems described herein include sharing of a subset of networks between clients to allow federated learning for weight-agnostic networks in which clients do not have samples from all classes.

### CROSS REFERENCE TO RELATED APPLICATIONS

This is a non-provisional application that claims benefit to U.S. Provisional Application Ser. No. 63/352,056, filed on Jun. 14, 2022, which is herein incorporated by reference in its entirety.

### FIELD

The present disclosure generally relates to neural networks, and in particular, to a system and associated method for training weight-agnostic networks in a federated learning setting.

### BACKGROUND

With the advent of data-hungry algorithms capable of performing convoluted computer vision tasks ranging from healthcare to automotive to manufacturing, it is of paramount importance to talk about the privacy and security concerns of the data being used. Conventional machine learning and deep learning algorithms are trained by centralizing all the data in a single machine or a data center. However, is the practice of centralizing data to perform training always feasible and “privacy-preserving”? Furthermore, challenges like high costs of storing large amounts of data, increased communication overheads, confidentiality concerns, and legal constraints are compelling enough to reconsider the assumptions of the standard practices to train a machine learning model.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustration of a typical federated learning workflow.

FIG. 2 is an illustration of an overview of a weight-agnostic neural network search.

FIG. 3 is a graph illustrating an example of non-iid data distribution.

FIG. 4 is a graph illustrating an example of orthogonal data distribution.

FIG. 5 is a set of graphs illustrating normal distribution vs. regression model using hand-crafted features.

FIG. 6 is a set of graphs illustrating normal distribution vs. different models using network matrix as features.

FIG. 7A is a graph illustrating mean squared error (MSE) for Client A as described herein.

FIG. 7B is a graph illustrating an R2 score (Client A).

FIG. 7C is a graph illustrating mean squared error (MSE) for Client B.

FIG. 7D is a graph illustrating an R2 score (Client B).

FIG. 8 is an illustration of an estimation framework included in the proposed approach described herein.

FIG. 9 is a set of graphs illustrating the use of the estimator for governing local evolution.

FIG. 10 is an illustration of an exchange of networks in WFNAS associated with the proposed WFNAS approach.

FIG. 11 is a simplified diagram showing an exemplary computing system for implementation of the framework of FIG. 10.

FIG. 12 is a set of images from the MNIST dataset.

FIG. 13 is a set of graphs illustrating effect of sharing percentage for p.

FIG. 14 is a set of graphs illustrating an effect of sharing percentage for q.

FIG. 15 is a set of graphs illustrating an effect of shared period for E.

FIG. 16 is a set of graphs illustrating no-sharing Vs 20-20-10 for non-iid data distribution.

FIG. 17 is a series of graphs illustrating comparison of per-class test accuracy: no-sharing vs. 20-20-10 sharing (Client A).

FIG. 18 is a series of graphs illustrating comparison of per-class test accuracy: no-sharing vs. 20-20-10 sharing (Client B).

Corresponding reference characters indicate corresponding elements among the view of the drawings. The headings used in the figures do not limit the scope of the claims.

### DETAILED DESCRIPTION

### Summary

The present inventive disclosure is directed towards a new method/approach to train small neural networks (including weight-agnostic networks) in a federated learning setting. The trained networks by different participants might have different architectures which makes weight averaging not applicable. Unlike traditional networks, weight-agnostic networks have a small size and are trained using neural architecture search. The approach includes the sharing of a subset of networks between clients. Aspects of the present approach can be implemented via one or more processors or processing elements, and the inventive concept described can take the form of a system, processor configured with operations/functions, machine-readable memory, and the like as further described herein.

### INTRODUCTION

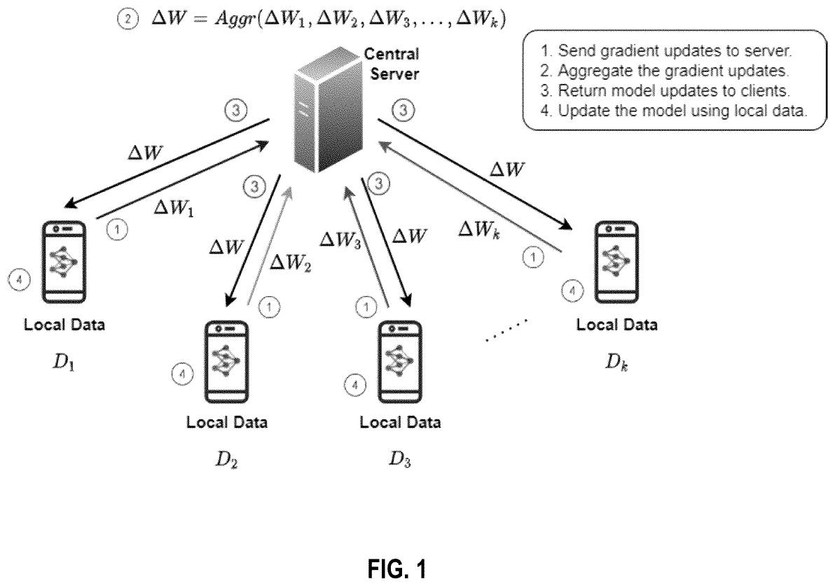

Federated Learning (FL) is a machine learning setting where multiple clients collaboratively solve a machine learning problem, under the orchestration of a central server where each client's data is only stored locally and does not leave the clients' device. Instead, appropriate statistics representative of the clients' local data such as gradient updates is shared for immediate aggregation at the central server to achieve the learning objective. It is noteworthy that these focused updates shared by the client are reduced to contain only the minimum information required for the global model to progressively move towards convergence. An illustration of a typical federated learning workflow is shown in FIG. 1. The key idea behind the Federated Learning approach, that is the ability to learn from the invisible data distributed among various clients in an unknown fashion is a long-standing goal for many research communities. There have been several early efforts to exploit the user data while preserving user privacy by leveraging cryptography techniques, but there is no single work in the literature yet that encompasses all the different challenges posed by federated learning. One of the primary reasons for this is that the open research problems in federated learning are fairly interdisciplinary and require the knowledge of distributed optimization, cryptography, differential privacy, compressed sensing, information theory, statistics, etc.

This disclosure particularly focuses on the unique requirements to automatically search for optimal neural architectures in a federated learning setting. Hand-crafting neural network architectures is a time-consuming process. For example, the CNN architectures are a result of an effort of decades that have a strong bias towards computer vision tasks. Furthermore, this challenge is fueled by the invisibility of clients' data in an FL setting, rendering handcrafted network architectures unfavorable for federated learning. To circumvent this, Neural Architecture Search (NAS) is a favorable and well-studied technique to automatically search for optimal neural network architectures using various optimization algorithms for a specific task on a specific dataset. There are three methods primarily used to perform NAS: evolutionary algorithms, reinforcement learning, and gradient descent. Although the recent progress in the NAS literature (in a non-federated setting) is quite phenomenal, this disclosure addresses the unique challenges that come into play while using the standalone NAS techniques in a federated learning environment.

Researchers in the FL community refer to the intersection of the above two areas as Federated Neural Architecture Search. This area has recently started receiving attention in the research community and very few papers have been published that address this exact problem. FedNAS is one of the pioneering works in this realm to help the scattered workers collaboratively search for a better network architecture with higher performance accuracy. Differentially-Private Federated Neural Architecture Search is built on top of FedNAS by adding noise to the gradient updates sent to the server. However, the aforementioned two papers follow a two-stage approach: 1) search and 2) parameter retraining, which is quite computationally exhaustive and infeasible in an FL setting. To address this problem, Garg et al. proposed an approach called Direct Federated Neural Architecture Search, which is capable of performing the NAS task in one step. This approach is based on Stochastic Neural Architecture Search (SNAS) and Discrete Stochastic Neural Architecture Search (DSNAS). The existing works elucidated so far are gradient-descent based approaches. Zhu et al. propose a multi-objective evolutionary offline federated learning that aims to minimize the communication overhead by simplifying the network structure and improving performance accuracy with weight-training in federated learning. In other works, an evolutionary approach to real-time federated neural architecture search that focuses on optimizing the model performance is proposed. All the aforementioned federated NAS approaches are applicable only for horizontal FL setting, where data is distributed by samples (horizontal), and not by features (vertical). According to Zhu et al., there is no single work in the literature of federated NAS for a vertical FL setting yet.

Out of the many core challenges of federated learning as identified and outlined, communication is a primary bottleneck since wireless links and other end-user internet connections typically operate at lower rates than intra- or inter-datacenter links and can potentially be expensive and unreliable. One of the key drawbacks of the existing Federated NAS techniques discussed above is that the neural networks searched by these techniques are very expensive in terms of size and memory. Such neural networks may not be feasible in a real-world setting to perform real-time inference after the deployment of the model. It is common for devices participating in the FL setup to be edge devices, IoT sensors, or mobile phones which have memory and computational constraints. This indicates a need for a Federated NAS technique that can search for much simpler networks that are easily deployable and are capable of performing real-time inference with low latency.

The existing works in the literature, be it gradient-based, reinforcement learning-based or evolutionary, focus on a joint-optimization of the weights w and architecture a, which makes the problem harder to solve especially in a communication-bound federated learning environment because the clients are required to send gradient updates for both the parameters for aggregation at the central entity. However, it was recently demonstrated that the machine learning task at hand can be solved using the innate characteristics of the network architecture itself. In other words, a randomly chosen single weight value can be used for all the connections to solve the machine learning problem solely on the basis of the connectivity of neurons in the network. Such networks are termed as “Weight Agnostic Neural Networks” (WANNs) and have not only shown performance accuracy comparable to the state-of-the-art networks for reinforcement learning and image classification tasks, but the searched networks are orders of magnitude smaller than the traditional networks. This makes WANNs highly favorable for deployment at edge devices for real-time inference in a federated learning setting. WANNs use the very popular and well-developed evolutionary algorithm named NeuroEvolution of Augmenting Topologies (NEAT) to evolve the networks of the current generation to obtain the next generation of high-performance network topologies.

Research Leading to Inventive Concept

Several experiments were performed in search of the proposed approach—WFNAS. The following sets forth the evolution of the WFNAS concept including questions and choices leading to the same.

Dataset: Experiments were performed on the Modified National Institute of Standards and Technology database (MNIST) benchmark dataset consisting of images of handwritten digits in order to have a fair comparison with the base (non-federated) approach (WANNs). The MNIST dataset consists of 60,000 training samples and 10,000 testing samples for handwritten digits from 0 to 9 (10 classes). All the images in the MNIST dataset are [28×28] grayscale (black and white) images. We did not consider other datasets for experimentation due to resource and time constraints.

Data distribution among clients: For emulating a federated learning environment, we consider two types of data distributions in our experiments: i) non-IID (non-identical and independent distribution) and ii) mutually exclusive division of data by classes.

Non-IID Data Distribution:

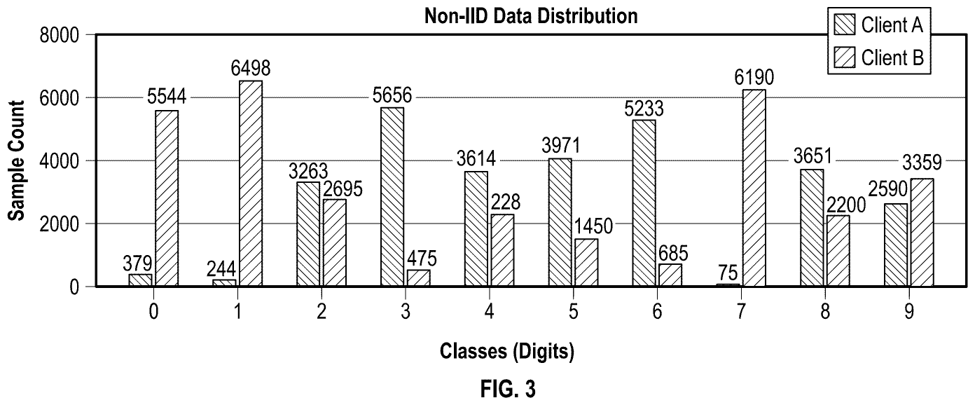

We generate a non-IID data distribution of the MNIST dataset by splitting the 60,000 training samples among the participating clients, indexed with k. Similar to FedNAS, we use the dirichlet distribution to divide the data in an unbalanced manner. More particularly, for each client, we sample the distribution of proportions p_{c}˜Dir_{J}(0.5) and allocate a P_{c,k} proportion of the training samples of class c to the client k. An example of a non-IID data distribution used to perform the experiments for the 2-client setting is shown in FIG. 3.

Mutually Exclusive/Orthogonal Data Distribution:

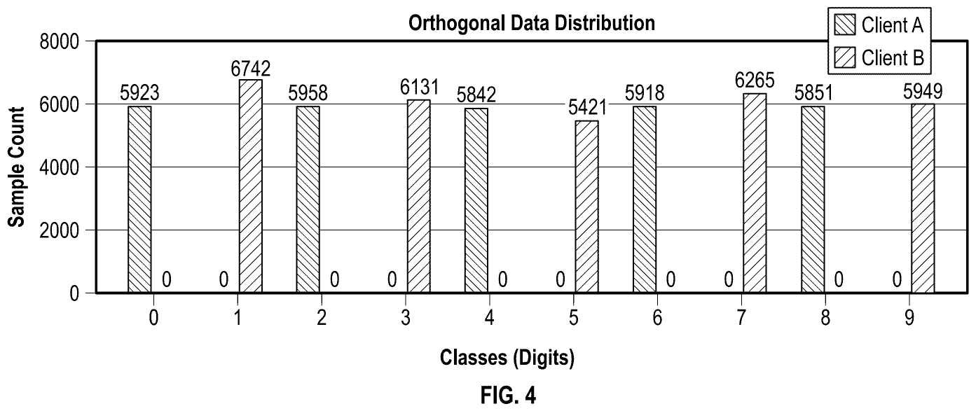

The MNIST dataset is considered fairly simple to learn as it consists of two-dimensional images of handwritten digits which are easy to distinguish. Therefore, the clients may learn how to predict the class correctly even with low number of samples without any exchange of networks in the case of non-IID data distribution. In order to prove the effectiveness of sharing networks using our proposed approach, we also consider the extreme case of data distribution which is dividing the entire dataset by classes in a mutually exclusive manner. In particular, we consider a 2-client setting, where one client has the data for all the even digits and the other client has the data for all the odd digits as shown in FIG. 4.

Trivial Exchange of Networks:

In order to implement a federated version of the WANNs, we began by experimenting with a simple exchange of networks with an expectation that merely sharing the locally evolved networks might help. So, each client would do the following: evolve the networks locally (based on the local data) and at the time of the global exchange or the sharing period, the clients simply exchange a certain percentage of their locally evolved networks with each other. Following the global exchange, all the networks are ranked based on the local data, and the best N networks are chosen for the next generation.

However, in the case of orthogonal data distribution, it was observed that the clients only learned the data on which they are trained locally and fail to perform on the other client's data despite mixing the networks. It was speculated that the trivial mixing of networks gave no chance to the networks that do well on the other data regardless of the percentage of networks shared. This indicated that there was a need for networks to be validated on the other client's data. Since the data cannot leave the client's device in a federated learning setting, the other alternative was to ask the client to validate the networks itself.

Estimation of Rewards:

One of the primary purposes of the global exchange of networks between the clients is to validate the networks on the other clients' local data in order to ensure the convergence of local evolution on the entire training dataset. The most straightforward way to perform validation would be to send all the local networks (sharing percentage=100%) from one client to all the other clients participating in the training process and receive the evaluation of those networks on their local data in return. However, sending all the networks for validation may not be feasible due to reasons such as increased communication overhead (growing in quadratic time for a two-client setting) and increased chances of privacy leak (learning information about the local data from the network topologies).

As a solution, we share only a certain percentage of the total local networks. Let the sharing percentage be denoted by p. Now, we use an estimator that can answer the following question: Based on the performance of the networks that were shared with the other client on their local data, how would the networks that were not shared perform on the other client's data? To the best of our knowledge, this problem has not been studied previously and our proposed approach for estimation is a novel contribution to the literature.

Comparison of Estimators:

In this section, we provide a detailed discussion and comparison of the various estimation techniques that were considered. At the end, we decide on the best features for the estimator to be used in WFNAS.

Mean

Since the networks in one generation do not differ by much and their rewards values do not have a huge variance, using the mean of the reward values as an estimate was the first approximation to evaluate the benefit of estimation. The idea is the following: In each local iteration, client A evolves its own networks and evaluates them on its local data. However, to validate its networks on the local data of client B, A sends p % of network architectures to B and receives the evaluations for those p % networks in return. Now, to estimate the evaluations for the remaining (100−p) % networks on the local data of B, the mean of the received reward values is used. The same process is performed at Client B as well.

Using the mean as an estimate showed a slight improvement in the results when training with mutually exclusive (orthogonal) data distribution as compared to only local training, which indicated that estimation is beneficial and using a better estimate can help reduce the number of networks that need to be shared for validation.

Normal Distribution

Using the normal distribution is another cheap estimation technique we used. In this approach, the mean and the standard deviation of the received reward values are evaluated which are then used to fit a normal distribution. Following that, to mate how the remaining networks would perform on the other client's data, random values are drawn from that normal distribution. This technique demonstrated better experimental results than using the mean as an estimator.

Hand-Crafted Features for Regression Model

The first two estimation techniques are weak. Instead, we needed a model that relates network characteristics to estimated performance on the other client's data. As an effort in that direction, we used a Decision Tree-based regression model that takes as input two manually handcrafted features of the networks shared with the other client: i) The average number of connections per node in each layer and ii) The number of nodes in each layer as X and the reward values for these networks on the other client's data as y. For the networks that are not shared, the same handcrafted features are calculated and the reward values for these networks are predicted using the trained regression model.

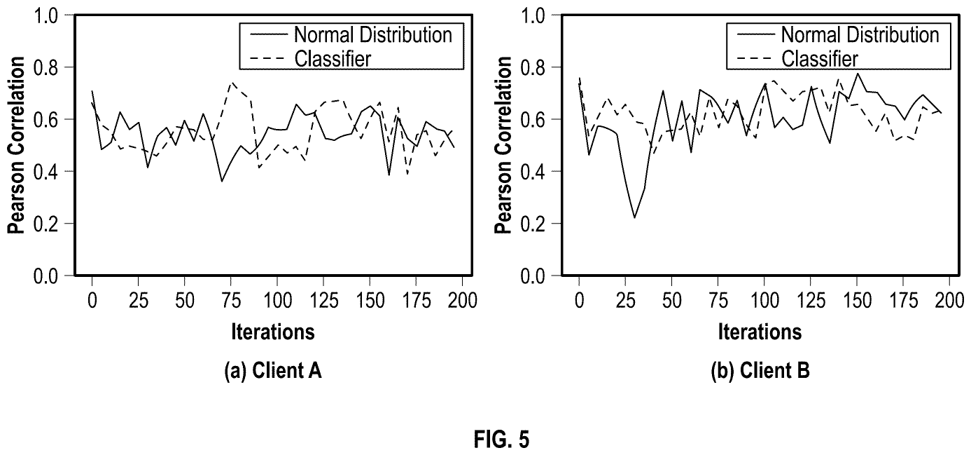

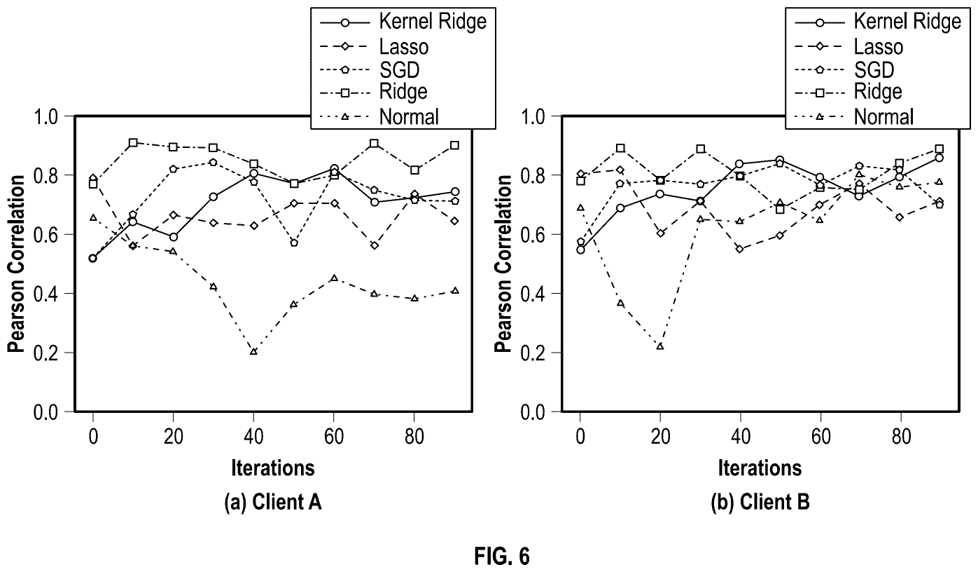

We performed an experiment for the non-IID data distribution (20% sharing after every 10 local iterations) to compare the estimation strength of hand-crafted features for the regression model (labeled as “classifier” in FIG. 5) and the reward values estimated using the normal distribution. More particularly, the plots in FIG. 3.3 are values of Pearson correlation [50] of both the approaches with the ideal ranking (the true ranking of networks if all the networks were shared with the other client for validation). The results indicate that using the machine learning-based approach performs no better than random values drawn from a normal distribution and the reason for this behavior is insufficient variety of features. In addition, the overall training time increased significantly with this approach because of the time spent in creating the feature vectors. Therefore, this approach is not favorable to be used in the actually training workload.

Network Matrix as Features

Each network is represented as an adjacency matrix A where the rows indicate the “connections from” and the columns indicate the “connections to”. An entry aᵢⱼ in the matrix A is 1 if nodes i and j are connected and 0 if they are not connected. The idea of using the entire networks as features was based on the intuition that instead of trying to use hand-crafted features, maybe the classifier/estimator learns important information from the networks themselves. The matrix is flattened to obtain a vector, which is then used as the feature vector for the regression model.

This approach demonstrated a better performance compared to the estimation using manually hand-crafted features and is significantly faster. However, one back of this approach is that as the iterations progress, the networks become bigger and therefore the matrices consume more memory eventually creating Out of Memory (OOM) issues in our testing environment.

As a solution, we used the sparse matrix representation in COOrdinate format provided by the scipy library in Python to represent the input features. The COOrdinate format essentially stores information about the indices having non-zero values in the original matrix using just three vectors: row, column, data, which sig-reduces the memory consumed by the matrix. Since the compression is lossless, we obtained the same performance with approximately 300× less memory consumption.

Once we have the compressed features—X_train (networks shared with the other client) and y_train (reward of shared networks on the other client's data), they are used to train a regression model such as a Support Vector Regressor or a Ridge Regressor. Following that, in order to obtain y_pred (prediction of the reward of networks not shared with the other client), X_test (networks not shared with the other client) is provided as an input to the trained regression model.

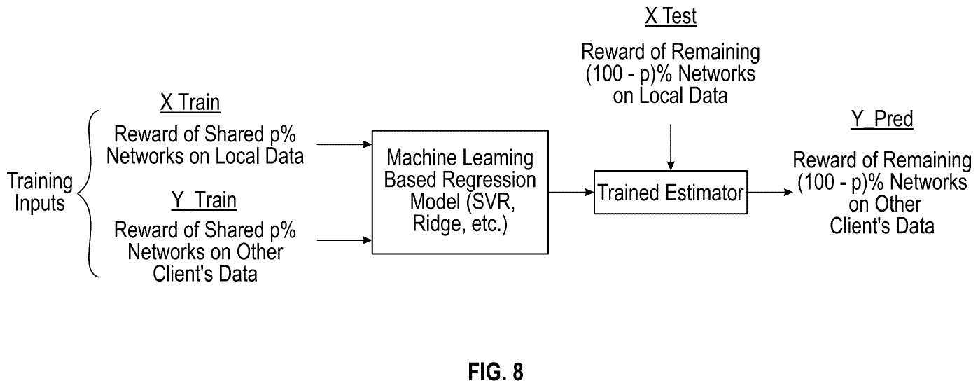

We performed an experiment for the non-IID data distribution (20% sharing after every 10 local iterations) to evaluate the performance of different regression models (such as Kernel Ridge, Lasso, SGD, and Ridge) trained using the network matrices as features and compare it with the estimation accuracy of Normal Distribution. The plot in FIG. 8 is a comparison of the Pearson correlation (higher is better) of rankings of networks obtained using different estimation techniques with the ideal ranking (the true ranking of networks if all the networks were shared with the other client for validation) after every global exchange. It is evident from the results that using the network matrix as a feature yields a better estimate of the rewards as compared to the normal distribution. Also, this study indicates that the choice of the regression model makes a considerable difference in performance. In this case, the “Ridge” regression model has superior performance than other regression models for both clients. The disparity in the performance of the estimators at both clients is due to the data distribution.

Rewards as Features

The mean squared error (MSE) of the regression model with networks as features was still considerably high, given that our aim is to reduce the sharing percentage as much as possible. Therefore, we used the local reward values themselves as training features. More particularly, the reward of shared networks on local data will be the X_train and the reward of shared networks on other client's data will be the y_train to train the regression model. Now, to estimate the performance of the networks that are not shared with the other client (y_pred), the reward of networks not shared on the local data (X_test) are provided as an input to the trained model.

Network Matrix Vs Rewards as Features

The mean, normal distribution and hand-crafted features were considered in the very initial stage of this work and due to their shortcomings as mentioned in their respective subsections, they were not considered for future experimentation. However, these trivial estimators showed the way to more sophisticated estimation techniques using networks and rewards as features.

Now, in order to decide which among the networks and rewards is a better choice, we performed an experiment for the non-IID data distribution in a 2-client setting where both the clients share 20% of their networks after every 10 local iterations. During every exchange, the reward values were estimated using both the types of features and then compared to the ideal reward (true evaluations of the networks not shared with the other client). Mean-squared error (MSE) (lower is better) and R2-score (coefficient of determination) (higher is better) are used as metrics to evaluate the effectiveness of both the features that are fed as an input to the Support Vector Regressor.

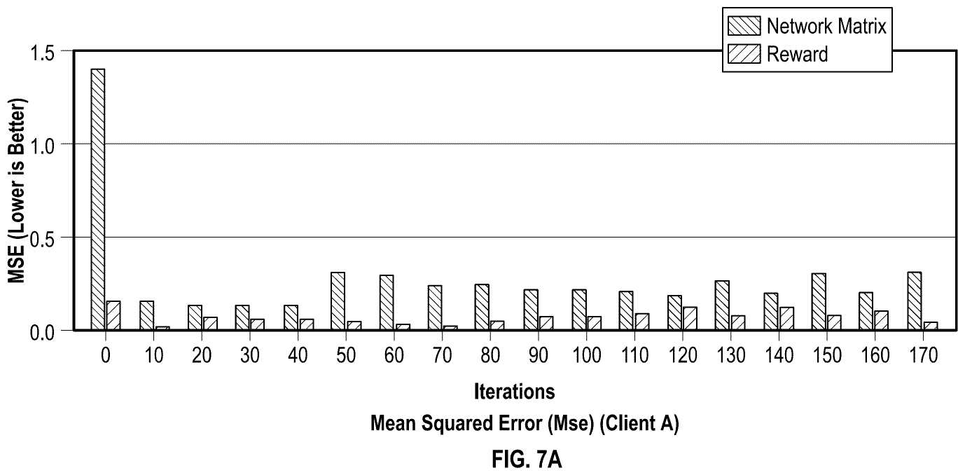

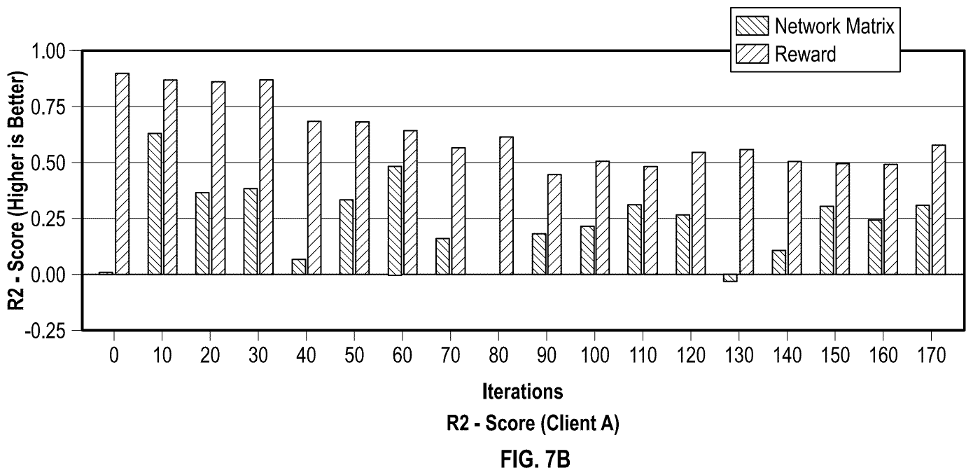

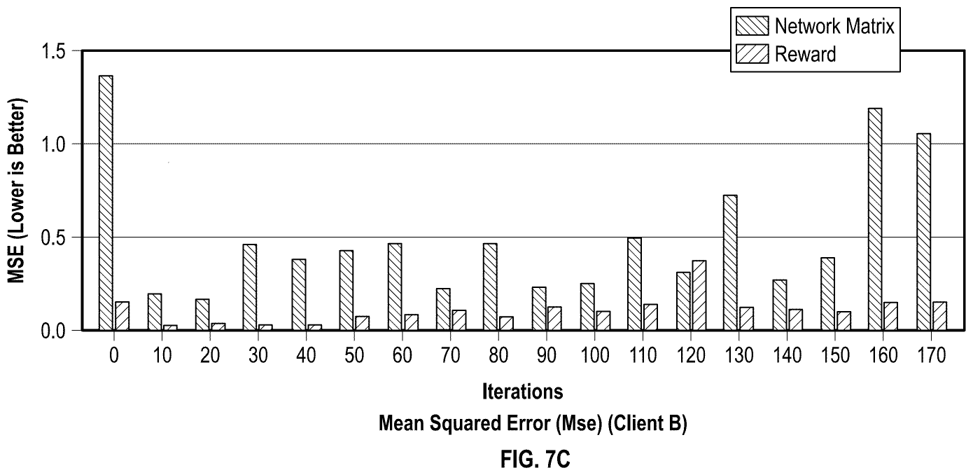

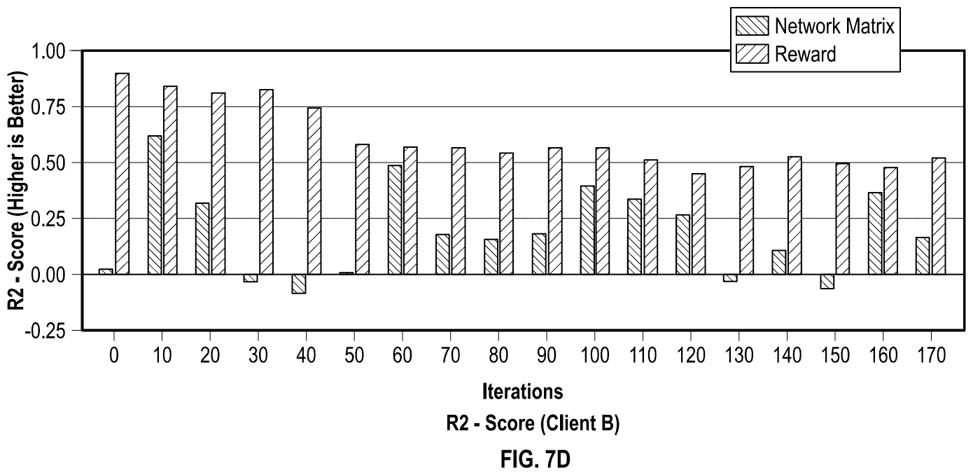

The experimental results in FIGS. 7A-7D clearly show that using the rewards as features to train the regression model is better than using the network matrix as features. Furthermore, this study allowed us to be able to share a smaller percentage of networks with the other client reducing the overall communication overhead.

Estimation Framework

A visual representation of the estimation framework used in the proposed approach is shown in FIG. 8.

Weighted Averaging of Rewards

Following the above discussion of estimation of rewards, the next question that comes up is how to combine the evaluations on both the clients in order to rank the networks locally. The most straightforward way to evaluate a network is to consider a simple average of the network's evaluation on both the clients' data and use that reward while ranking the networks. For example, to evaluate the reward of network i, ri in an K-client FL setting,

$${r}_{i} = \frac{1}{K} {\sum }_{k = 0}^{K} {r}_{i} ( k )$$

where, rᵢ(k) represents the reward of network i on client Ks data.

However, an assumption for the above case is that we are implicitly giving equal importance to the evaluation of all the clients. But, for instance, consider the case of non-IID data distribution (for example, the distribution shown above), where client A has only 75 samples of digit 7, whereas client B has 6190 samples of digit 7. Intuitively, it makes more sense to give more weight to the evaluation of client B compared to the evaluation of client A for digit 7. Therefore, we propose to use a per-class weighted reward as below:

$$= \frac{1}{C} {\sum }_{k = 0}^{K} {\sum }_{c = 0}^{C} \frac{{K}_{k c}}{K c} {r}_{i} ( k c )$$

where, C denotes the number of classes (in our case, 10), K_{kc} denotes the number of samples of class c with client k and rᵢ(kc) represents the reward of network i on the data of class c on client k.

Note that the approach for weighted averaging assumes that each client has information about the number of samples with every other client, which indicates leakage of information. Empirical results demonstrated a higher performance accuracy with weighted averaging of rewards during the global exchange as compared to simple averaging.

Choosing which Networks to Share?

At the time of the global exchange, p % networks are shared with the other client for validation and combination purposes. However, it is important to decide which networks to choose for sharing as they impact the estimation as well as the combination performed after the global exchange and therefore the overall performance. In order to investigate the matter, we performed a detailed analysis on how to choose the networks for sharing. Intuitively, it might seem that choosing the best-performing networks locally should be the way to go, but, our study indicates that choosing randomly from all over the population of networks is better.

Consider the experiment setup where each client shares 20% of networks chosen randomly from its entire population of networks after every 5 local generations. Now, the idea is to see whether the networks that survive at the other client after the exchange are from the group of high-performing local networks or from the group of low-performing local networks or a mix of both.

In order to do that, 20% of networks are chosen randomly, evaluated on the local data and both the networks and their evaluations are shared with the other client. The other client that receives the networks, evaluates them on its own local data and performs weighted averaging of the reward based on the number of samples per class with both clients to obtain the final reward. Using this reward, the networks are ranked and the best networks are chosen from the pool of its local networks and the imported networks (evaluated on both the client's data). We consider different bands of low and high-performing networks (10%, 20%, 30%, 40%) for the sake of reliability of our results and calculate the following ratios:

$$Ratio A : \frac{\# of survivors from low}{Total \# of survivors}$$

$$Ratio B : \frac{\# of survivors from high}{Total \# of survivors}$$

$$Ratio C : \frac{\# of survivors from low that were sent}{\# of low that were sent}$$

$$Ratio D : \frac{\# of survivors from high that were sent}{\# of high that were sent}$$

The above ratios can serve as a metric to determine the distribution of the network ranks at one client that survive at the other client. The results shown in Table 3.1 and Table 3.2 are an average of the ratios obtained over 100 iterations (20 exchanges).

TABLE 3.1
Client A: Experiment Results for Choosing Networks for Sharing

| Low and High | | | | |
|---|---|---|---|---|
| Rank % Band | Ratio A | Ratio B | Ratio C | Ratio D |
| 10% | 0.08 | 0.10 | 0.60 | 0.80 |
| 20% | 0.16 | 0.20 | 0.75 | 0.91 |
| 30% | 0.27 | 0.31 | 0.84 | 0.96 |
| 40% | 0.36 | 0.43 | 0.79 | 0.92 |

TABLE 3.2
Client B: Experiment Results for Choosing Networks for Sharing

| Low and High | | | | |
|---|---|---|---|---|
| Rank % Band | Ratio A | Ratio B | Ratio C | Ratio D |
| 10% | 0.07 | 0.11 | 0.65 | 0.98 |
| 20% | 0.16 | 0.22 | 0.70 | 0.91 |
| 30% | 0.25 | 0.32 | 0.76 | 0.98 |
| 40% | 0.35 | 0.44 | 0.74 | 0.95 |

As the total # of survivors will be less than or equal to 20% (sharing percentage) of the total number of networks for this experiment, the ratios A and B are expected to increase with the increasing percentage of low and high networks considered due to randomness in selection of networks. Also, if either ratio C or D was consistently low for all the percentage bands, then it would indicate that considering networks from that percentage band is not a good idea. However, as evident from the above results, ratios C and D are consistently high which indicates that the networks that survive at the other end come from all over the population. This study lead us to adopt random selection for the shared networks.

Historical Networks

As a part of the effort to understand areas of improvement in our approach, we observed that for the experiments with a configuration of sharing period greater than 1, we might potentially be losing out on good networks obtained during the local generations. Therefore, the idea of using historical networks was to retain a certain percentage of networks from every local generation and then at the time of global exchange, randomly choose networks for sharing from the pool of current generation of networks and the retained historical networks. However, the approach did not show much promise based on the overall results and therefore the idea was eventually dropped for further experiments.

Separately Evolving Imported Networks

For sharing period greater than 1, analyzing the performance of the best-performing networks of both the clients on individual classes indicated that sharing is not helping the classes that have a lower number of samples. An intuition for justifying the behavior was that the networks that were imported from the other client although they make it to the next generation based on the weighted validation of rewards, but eventually do not survive in the local evolution process as a certain percentage of networks are culled from every generation in the evolution process of the NEAT algorithm.

In order to make them survive intentionally, instead of choosing the best-performing networks right after the global exchange, an idea was to retain the imported networks and evolve them separately from the local networks using the local data. At the end of a set of local generations, the best-performing networks from the locally evolved local and imported networks are chosen to perform the global exchange. The expectation was that this will give a chance to the imported networks to evolve on the other client's data. It was expected that this approach can closely imitate the case where all the clients had access to the local data of all the other clients.

The results for this experimental approach indicated a higher overall performance accuracy on the test dataset, but it did not specifically help the classes have low number of samples. Therefore, this idea was dropped subsequently.

Estimator for Local Rewards

In order to reduce the total cost of communication between clients, it is necessary to increase the interval of exchange of networks between clients. At the time of the exchange, as discussed herein, a machine learning based estimator is trained to predict the performance of the networks that are not shared with the other client on their data. The idea of this set of experiments was to utilize this trained estimator for prediction even during the local generations. For example, consider a configuration where both the clients exchange 20% of their networks after every 10 local generations. Now, after the clients perform an exchange during the 10^{th} local generation, they have a trained estimator that is capable of predicting the performance of their local networks on the other client's data. Instead of evolving the networks by ranking them on the local data, the clients use this estimator to calculate the weighted average of the reward (as discussed herein) to rank and evolve the networks until the next exchange. After the second exchange of networks during the 20^{th} generation, the newly trained estimator is used for the next 10 local generations, so on and so forth.

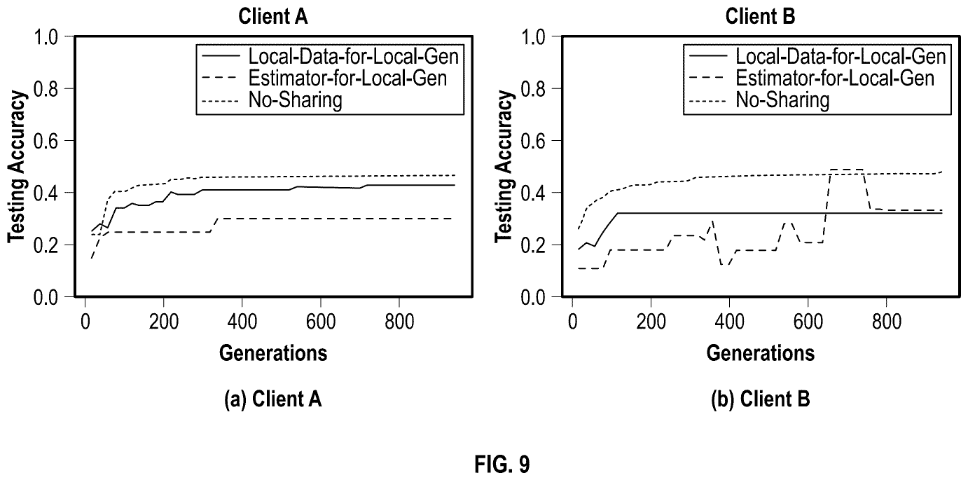

The experimental results (also shown in FIG. 9) showed that the overall test performance reduced even in comparison to the evaluation only on local data during the local generations due to the following reasons: i) Since the reward values are used as features to train the estimator, it was observed that the estimator produces stale values that are outdated as the generations progress further and ii) the estimator itself is not perfect and relying on it beyond the global exchange seems to have limited benefit. Furthermore, the performance with and without estimator is worse than no-sharing indicating that a sharing period more than 1 needs further research.

Informed Sharing

The results above indicated that randomly choosing networks to share with the other client is the best approach for two reasons: i) train the estimator well because of the variety of networks and ii) the experiments suggested that the survivor networks after the global exchange come from all over the population. These conclusions were made based on the ranking obtained from the local data of the client. However, the idea behind informed sharing is that it intuitively makes more sense to rank the data based on the entire dataset and then exchange the best-performing networks among the clients. Since the clients do not have access to each other's data, we perform two sets of exchanges as a part of the global exchange: i) randomly share p % networks to obtain the estimator and ii) rank the networks on the entire data using the estimator trained in the first exchange and share the best-performing q % networks. If the estimator is ideal, this approach seems more promising than random sharing in one exchange. A shortcoming of this approach is the increased communication overhead. However, this technique demonstrated a increased performance accuracy as expected and is therefore used in the proposed approach.

WFNAS Approach

In this disclosure, the idea of WANNs is extended to the realm of federated learning and provide a system that implements a framework for neural architecture search that can eliminate the weight-training and hyperparameter tuning process. For the sake of simplicity and due to resource constraints, the study was restricted to a 2-client FL setting, but we provide information to easily extend the work to a multi-client FL setting as a part of future work. For the ease of understanding, let the participating clients be denoted by “A” and “B”. Both the clients evolve their networks locally based on their respective local data using a search process. After every iteration, the low-performing networks are eliminated as a part of the evolution process. However, the networks that are low-performing on Client A's data may not be low-performing on Client B's data and vice versa. Therefore, to validate the performance of the locally evolved networks on the other client's data, this disclosure provides the system and associated framework that implements the below:

Client A sends p % of its network architectures to Client B and receives the evaluated reward for those networks. To obtain the reward for the remaining (100−x) % networks on the local data of Client B, the system uses a robust estimation technique to predict the performance of the remaining (100−x) % of networks on the local data of Client B. The networks of Client A are ranked based on their evaluations on Client A's data and Client B's data and the best-performing q % networks are sent to Client B again.

The same approach applies for Client B. The framework can be evaluated on two types of FL settings: i) vertical (orthogonal data distribution) and ii) horizontal (non-IID data distribution) and compare it with the performance accuracy of standalone (local) training using the same data distributions. The experiments demonstrate a gain of nearly 40% points for vertical FL and about 2% points for horizontal FL even though MNIST performs well in standalone training.

Evidently, the framework has two major differences in comparison to the standard FL architecture: 1) Since the networks searched the framework are weight-agnostic, no gradient updates are shared by the client. Instead, each client shares a certain percentage of networks evolved locally. 2) There is no central entity in the proposed network, instead each client shares its networks with the other clients in a decentralized manner.

The contributions of this work can be outlined as follows:
A novel weight-agnostic neural architecture search framework is proposed for a federated learning environment for the first time in the literature. The proposed approach is capable of searching for lightweight networks (in terms of size and memory) that demonstrate performance accuracy comparable to the non-federated setting.
This work serves as the first federated learning NAS technique that works for vertically distributed data. In addition, we also evaluate our approach for horizontally distributed data in a non-IID fashion.
Extensive experiments have been conducted to test the hypothesis for all the independent aspects of the proposed approach. For example, choosing which networks to share, tuning the sharing percentage and sharing period for high-performance networks, etc.

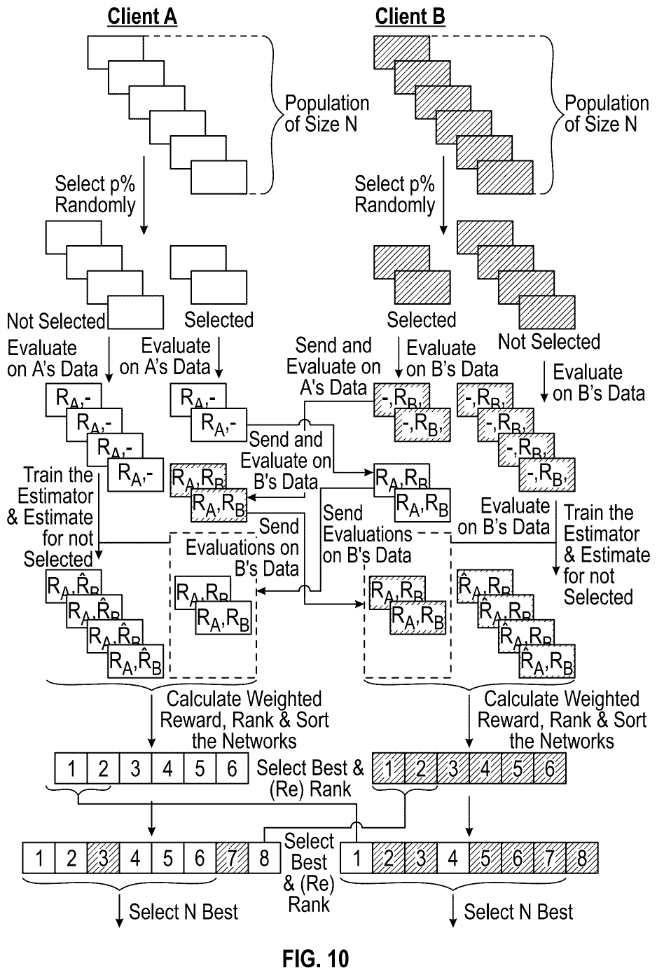

With reference to FIG. 10, system implementing the framework includes a federation of two clients A and B participating in a neural architecture search. Let the total number of generations/iterations be denoted by G and the interval at which the networks are exchanged be denoted by E. Therefore, the number of generations evolved locally before an exchange will be E and the total number of network exchanges will be G/E.

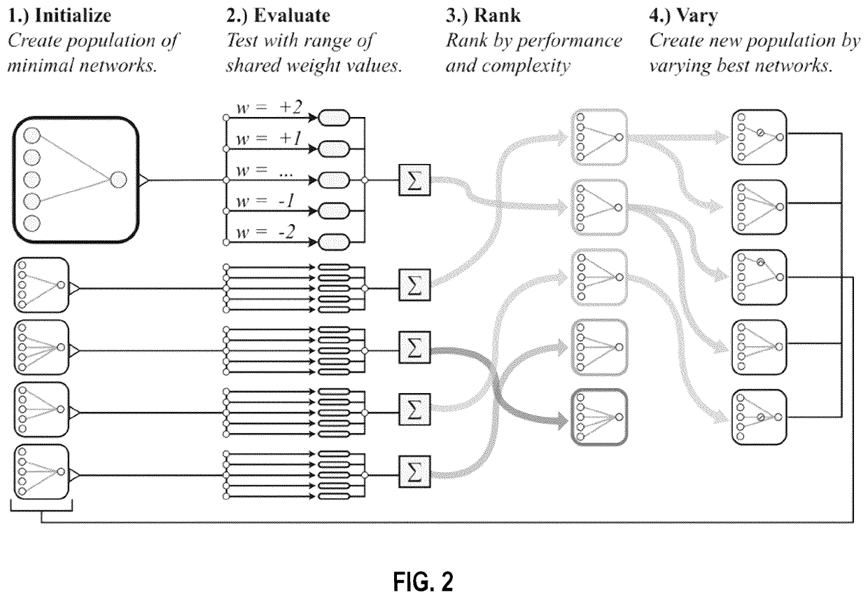

The steps of the present framework implemented by the system at Client A can be outlined as below. Similar steps are simultaneously performed at Client B.
1. Initialize a population of minimally connected networks at Client A.
2. For local generations (if (g=0) or (g mod E)≠0),
   (a) Evolve the networks of the current generation g and rank them based on the local data of Client A as shown in FIG. 2, however, instead of randomly choosing samples from the entire local dataset for evaluation of networks, choose randomly from each class and then average the evaluations on 10 classes. This averaged reward will be used to rank the networks for the next generation.
3. For global exchange of networks for validation (if (g mod E)≠0), and g≠0) (refer to FIG. 10),
   First Exchange
      (a) Randomly select p % of the networks in the current generation g (where p is a parameter for the first exchange).
      (b) Evaluate the selected and the remaining networks on each class of the local data of Client A.
      (c) Send the selected networks with their per-class local reward to Client B. Client B returns the per-class reward (evaluation) of shared networks of Client A on Client B's data.
      (d) Similarly, Client B sends p % of its networks and their per-class reward on Client B's data to Client A. Now, Client A evaluates the received networks on local data of Client A and sends the per-class reward back to Client B.
      (e) Using the evaluation of shared networks on both clients' data, train an estimator using the rewards per class as features for the regression model as shown in FIG. 8 and discussed herein. With the help of the trained model, estimate how the remaining (not shared) networks would perform on Client B's data.
      (f) At this point, all the networks of the current generation have either an evaluation or an estimation for each class on both the client's data.
      (g) Perform weighted averaging of rewards based on the number of samples per class with each client as discussed herein.
   Second Exchange
      (a) Rank the networks based on this weighted reward and send the best-performing q % networks to Client B (where q is a parameter for the second exchange).
      (b) Similarly, Client A will receive the best q % networks from Client B.
      (c) Rank the pool of networks (Client A's local+Client B's best q %) again and choose the best-performing N networks for the next generation.
4. Increment g and repeat steps 2 and 3 for G generations.

The proposed approach for a 2-client FL setting can be extended to an N-client FL setting by having each client exchange networks with every other client. Consequently, the estimator used to predict performance on the other client's data will be unique to each client and the final reward for ranking the local networks will be a weighted average of the reward obtained from all the clients based on the number of samples per class with each client. Note that with N clients, the number of exchanges scale quadratically −O(n²).

In some embodiments, the system can send multiple “categories” of network between clients in the use of estimation. For instance, if a client evaluates the networks locally, these networks can be divided into categories depending on some characteristics of the networks that the client deems important. Then, the client can select networks from these categories to share with the other client. The choice can be random or not.

### Computer-Implemented System

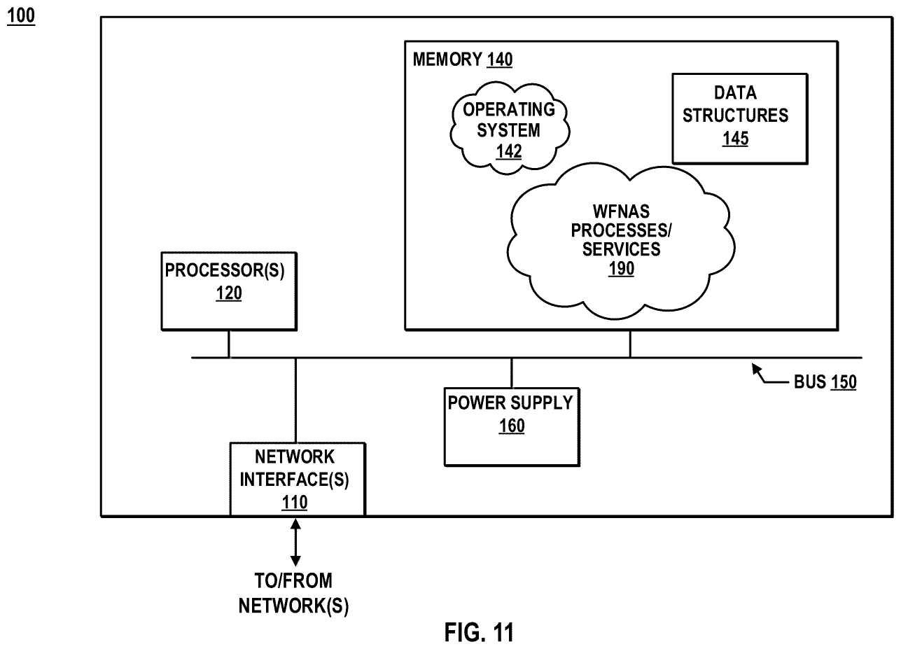

FIG. 11 is a schematic block diagram of an example device 100 that may be used with one or more embodiments described herein, e.g., as a component of the system and/or as a computing device that implements aspects of the framework described herein.

Device 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.).

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, device 100 may have limited memory or no memory (e.g., no memory for storage other than for programs/processes operating on the device and associated caches).

Processor 120 comprises hardware elements or logic adapted to execute the software programs (e.g., instructions) and manipulate data structures 145. An operating system 142, portions of which are typically resident in memory 140 and executed by the processor, functionally organizes device 100 by, inter alia, invoking operations in support of software processes and/or services executing on the device. These software processes and/or services may include Weight-Agnostic Federated Neural Architecture Search (WFNAS) processes/services 190 which can include a set of instructions within the memory 140 that implement aspects of the framework when executed by the processor 120. Note that while WFNAS processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the WFNAS processes/services 190 is shown as a standalone process, those skilled in the art will appreciate that this process may be executed as a routine or module within other processes.

Experimental Results and Discussion

A detailed discussion of the experiments that highlight the effectiveness of the proposed approach are provided. We begin by describing the dataset and the experimental setup, followed by several experiments performed to understand the impact of various parameters of the proposed approach.

Dataset & Image Preprocessing

As the primary goal of this study is to explore the feasibility of weight-agnostic neural network search in a federated learning setting, we use the MNIST dataset consisting of images of handwritten digits (0 to 9) so that we can compare our results to the non-federated setting (we did not consider other datasets due to time and resource limitations).

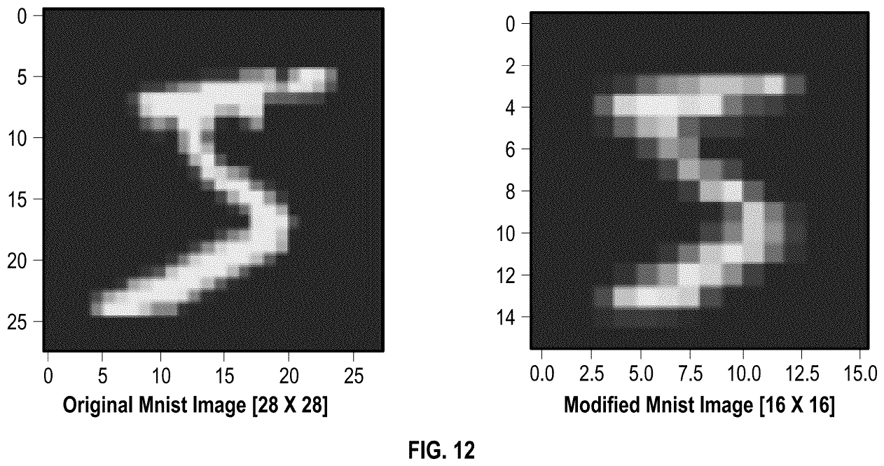

For the sake of consistency with the non-federated WANNs, all the images in the MNIST dataset are downsampled by reducing the size of the images from [28×28] to [16×16] followed by the deskew operation using the OpenCV library and pixel intensity normalization between 0 and 1. In FIG. 12, a visual representation of a sample image of digit 5 before and after performing resize, crop and deskew operations is shown.

We tested the results of all the experiments using the MNIST testing dataset (after applying the same image pre-processing steps mentioned above). It contains a total of 10,000 samples (see Table 5.1 for distribution of samples among classes).

TABLE 5.1
Mnist Test Dataset

| Classes (Digits) | 0 | 1 | 2 | 3 | 4 | 5 | 6 | 7 | 8 | 9 |
|---|---|---|---|---|---|---|---|---|---|---|
| # of samples | 980 | 1135 | 1032 | 1010 | 982 | 892 | 958 | 1028 | 974 | 1009 |

Experimental Setup

In this study, we restrict our experiments to a two-client federated learning setting due to computational resource limitations. Let the two clients be denoted by “A” and “B”. As discussed in Chapter 4, each client evolves N networks per generation locally for G generations and performs two sets of exchanges of networks (p % and q % of networks respectively) after every E local generations.

We implemented the experimental setup in two ways: i) on a single node and ii) in a distributed setting. In i) both clients “A” and “B” execute in parallel using mpi4py library in Python leveraging the various cores on a single node/machine. In ii) each node represents a client (similar to a federated learning setting) that performs evolution of its networks locally and the communication/exchange of networks is done between the nodes using scp (secure copy protocol) in a synchronous manner.

Orthogonal Data Distribution

We consider a mutually exclusive division of the entire MNIST dataset among two clients as discussed above. Client A has the data of 29, 492 samples of all the even digits (0, 2, 4, 6, 8) and client B has the data of 30, 508 samples all the odd digits (1, 3, 5, 7, 9) (see Table 5.2 for per-class distribution of samples between clients). Since client A has zero samples of odd digits and client B has zero samples of even digits, there is no way for them to learn how to classify odd and even digits respectively. However, we show that our proposed federated NAS algorithm is capable of searching for networks that perform well on all the digits in the testing set. To the best of our knowledge, this is the first federated NAS technique proposed in the literature for vertical FL and hence we do not have any prior results to compare to. Therefore, we compare the results of our proposed approach with the results of non-federated standalone NAS of clients on their local data. In what follows, we present results that show the effect of various parameters in our proposed algorithm such as the sharing percentages and the sharing period.

TABLE 5.2
No. Of Samples per Class in Orthogonal Data-distribution

| Classes (Digits) | 0 | 1 | 2 | 3 | 4 | 5 | 6 | 7 | 8 | 9 |
|---|---|---|---|---|---|---|---|---|---|---|
| # of samples | 5923 | 0 | 5958 | 0 | 5842 | 0 | 5918 | 0 | 5851 | 0 |
| with Client A | | | | | | | | | | |
| # of samples | 0 | 6742 | 0 | 6131 | 0 | 5842 | 0 | 6265 | 0 | 5949 |
| with Client B | | | | | | | | | | |

Effect of Sharing Percentages

As discussed herein, the algorithm for WFNAS includes two sets of exchanges where p % of networks from the total population are shared with the other client in the first exchange and q % of networks are shared in the second exchange. The goal is to minimize the sum of p and q as it accounts for the total communication overhead of the proposed approach. First, we perform experiments by fixing the value of q to find a good value of p, and once we have the desired value of p, we vary the percentage of networks shared in the second exchange to find a good value of q.

The First Exchange

The first exchange of networks is very crucial as the performance of the estimator depends on it. The higher the number of networks shared in the first exchange, the better will the estimator be, as the machine learning-based regression model will have more training data. At the same time, we also want to reduce it as much as possible to reduce the overall communication cost. We fix the value of q to 40% and vary the values of p to search for optimal values using an approach similar to the grid search. Thus, we consider the following values of p—[5%, 10%, 20%, 40%] and exchange the networks after every generation (E=1) for a total of 2000 generations, where each client has N=960 networks per generation. The value of N is chosen as 960 for consistency with the non-federated version of WANNs. In addition, we compare the results of all the four different configurations of p with the case where the clients do not perform any exchange of networks and only search for networks using their local data.

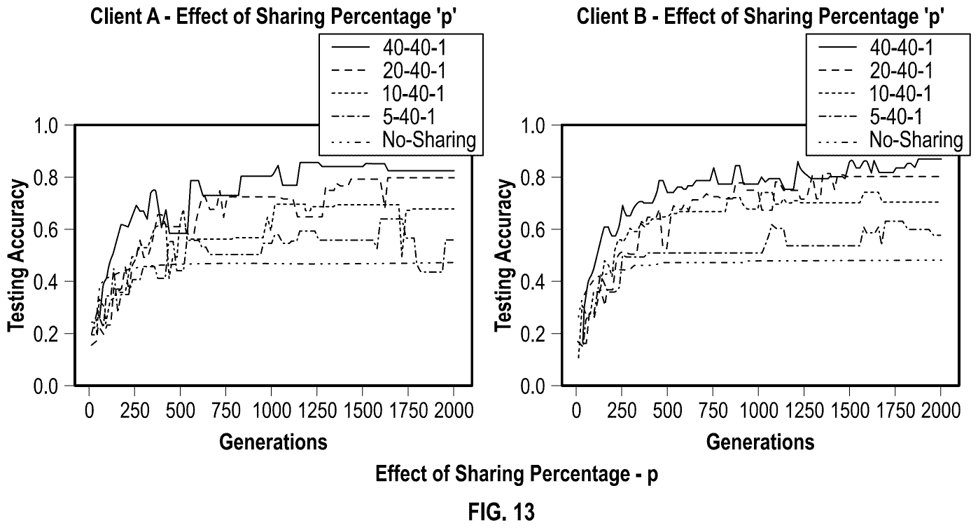

The results in FIG. 13 indicate a consistent trend of better performance with a higher value of p for both clients A and B as anticipated. Also, in the case of no-sharing, both the clients perform well only on the digits for which they are trained locally, hence the test accuracy is less than 50%. On the contrary, the overall test performance for all the other configurations using our proposed approach is beyond 50% demonstrating the effectiveness of our algorithm. See Table 5.3 for reference.

TABLE 5.3
Comparison of Test Accuracy for Different Values of p

| | |
|---|---|
| xperiment | |
| Configuration | Test Accuracy |

| (p-q-E) | Client A | Client B |
|---|---|---|
| no-sharing | 47.09% | 48.29% |
| 5-40-1 | 56.12% | 57.85% |
| 10-40-1 | 68.08% | 70.44% |
| 20-40-1 | 79.67% | 80.13% |
| 40-40-1 | 82.48% | 87.08% |

The Second Exchange

The second exchange is contingent on the performance of the estimator trained using the first exchange of networks, which requires choosing an optimal value of p. As the local networks shared in the second exchange will be mixed with the population of networks on the other end, it is expected that the higher the value of q, the better the overall performance will be. We fix the value of p=20 as it seems to balance the trade-off between performance accuracy and communication overhead from FIG. 5.3 and vary the value of q as follows—[5%, 10%, 20%, 40%]. The values of other parameters are kept the same as earlier (N=960, G=2000, E=1).

TABLE 5.4
Comparison of Test Accuracy for Different Values of q

| | |
|---|---|
| Experiment | Test Accuracy |

| (p-q-E) | Client A | Client B |
|---|---|---|
| no-sharing | 47.09% | 48.29% |
| 20-5-1 | 76.21% | 69.56% |
| 20-10-1 | 81.84% | 77.36% |
| 20-20-1 | 79.19% | 76.65% |
| 20-40-1 | 79.67% | 80.13% |

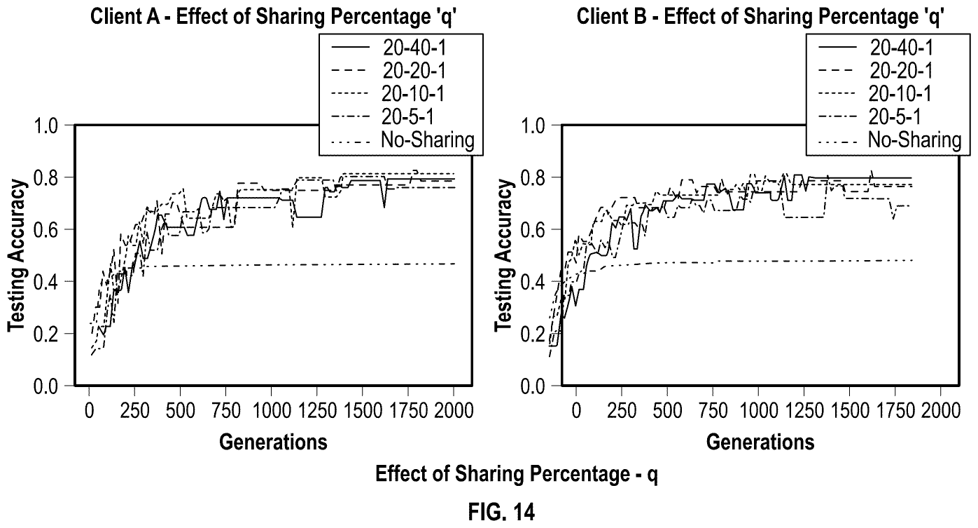

As evident from FIG. 14, in general, there is an increasing trend in the overall testing accuracy of both clients by increasing the sharing percentage q. In Table 5.4, we summarize the results obtained by varying the sharing percentage q.

Effect of Sharing Period

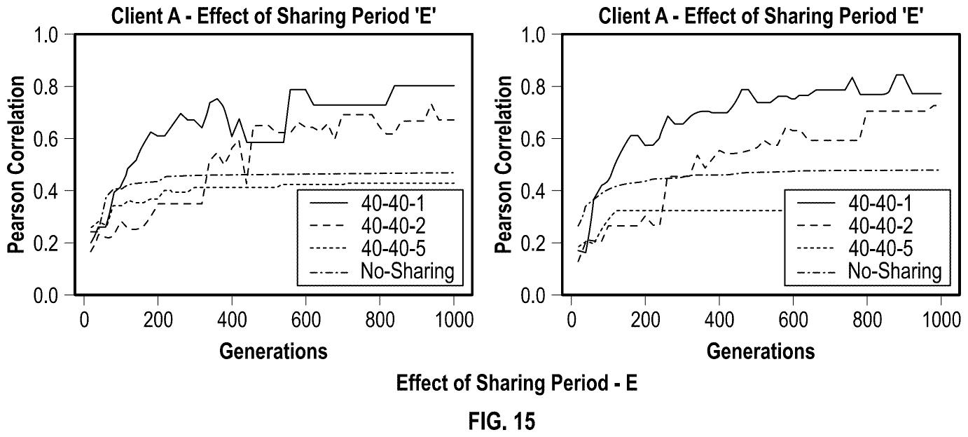

The motivation to study the effect of sharing period is that the higher the sharing period (E), the lower will the frequency of exchange of networks between the clients be, and thus, the communication cost will be lower. For orthogonal data distribution, evolving networks locally for 5 generations (using their local data) and then exchanging networks for validation at every 5^{th} generation results in a significant drop in overall performance even below the baseline case of no-sharing as shown in FIG. 15 and Table 5.5.

Our intuitive explanation for this phenomenon is that after the exchange of networks, the imported networks do not survive in subsequent local generations. For example, after importing 40% of networks from client B (having data of odd digits) at client A (having data of even digits), the imported networks never get a chance to be evaluated on the data of odd digits for the next 5 local generations, which is why there is no way for them to survive until the next exchange.

TABLE 5.5
non-IID data distribution

| | |
|---|---|
| Experiment | |
| Configuration | Test Accuracy |

| (p-q-E) | Client A | Client B |
|---|---|---|
| no-sharing | 47.09% | 48.29% |
| 40-40-1 | 82.48% | 87.08% |
| 40-40-2 | 67.11% | 72.76% |
| 40-40-5 | 42.77% | 32.21% |

Non-IID Data Distribution

In this section, we discuss the experimental results when the data distribution among the clients is non-IID. Using Dirichlet distribution, we generate a non-IID data distribution (see Table 5.6 for per-class distribution of samples between clients) to perform experiments with our proposed approach where client A has a total of 28, 676 samples and client B has a total of 31, 324 samples.

TABLE 5.6
No. Of Samples per Class in Non-iid Data-distribution

| Classes (Digits) | 0 | 1 | 2 | 3 | 4 | 5 | 6 | 7 | 8 | 9 |
|---|---|---|---|---|---|---|---|---|---|---|
| # of samples | 379 | 244 | 3263 | 5656 | 3614 | 3971 | 5233 | 75 | 3651 | 2590 |
| with Client A | | | | | | | | | | |
| # of samples | 5544 | 6498 | 2695 | 475 | 2228 | 1450 | 685 | 6190 | 2200 | 3359 |
| with Client B | | | | | | | | | | |

TABLE 5.7
Comparison of Test Accuracy for Non-iid Data Distribution

| | |
|---|---|
| Experiment | |
| Configuration | Test Accuracy |

| (p-q-E) | Client A | Client B |
|---|---|---|
| no-sharing | 85.38% | 87.81% |
| 20-20-10 | 85.36% | 89.16% |

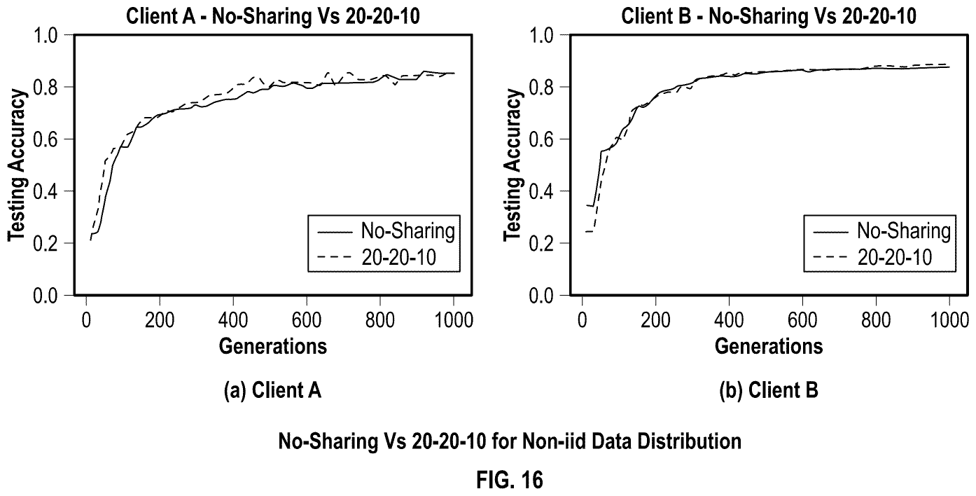

As evident from Table 5.6, there are several classes with high disparity in the distribution of data such as digit 7 with only 75 samples with client A and 6150 samples with client B. However, despite having lower number of samples for certain classes at both clients, we observe that the clients are able to search for well-performing networks with a test accuracy similar to non-federated WANNs even without requiring any exchange of networks. FIG. 16 and Table 5.7 show a comparison for two configurations: i) no exchange of networks and ii) first exchange of 20% of networks (p=20) and second exchange of 20% of networks (q=20) between clients after every 10 local generations for 1000 generations (G=1000) is performed using non-IID data distribution. Even though the baseline (standalone training) performance with MNIST is quite well, we see a gain of 2% in the overall test accuracy with WFNAS.

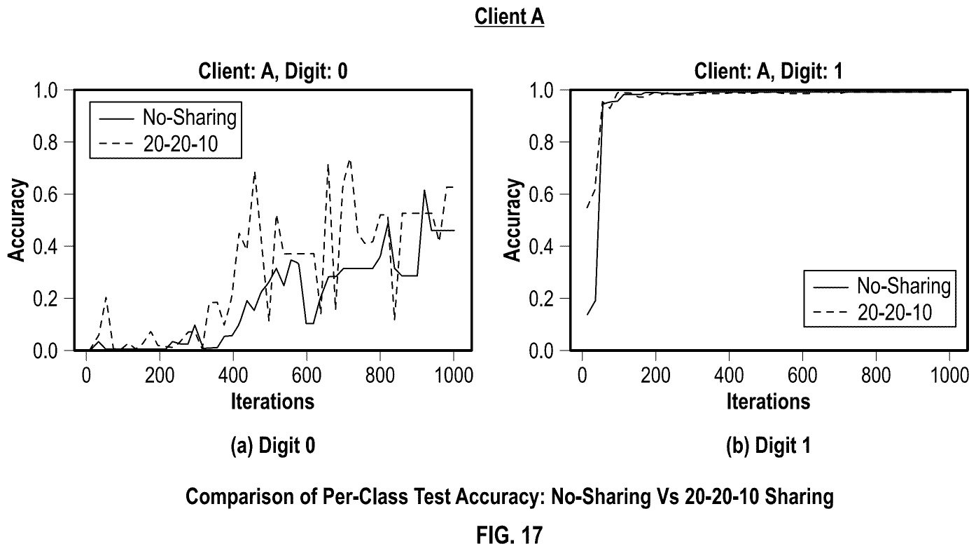

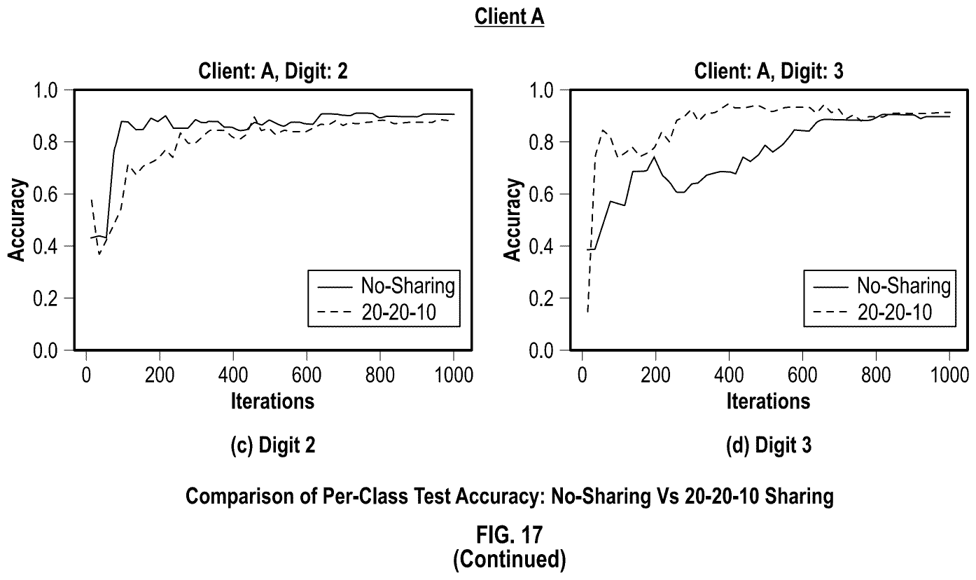

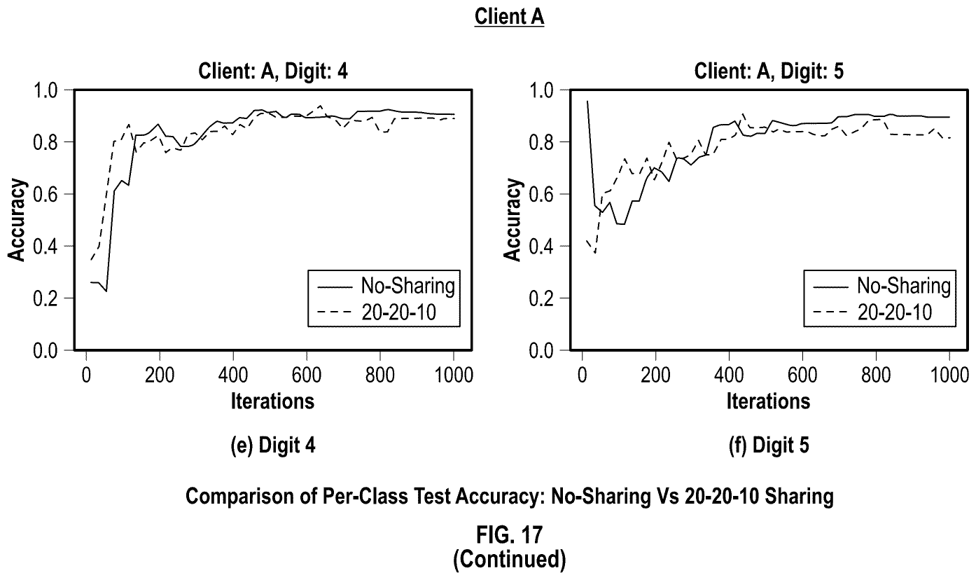

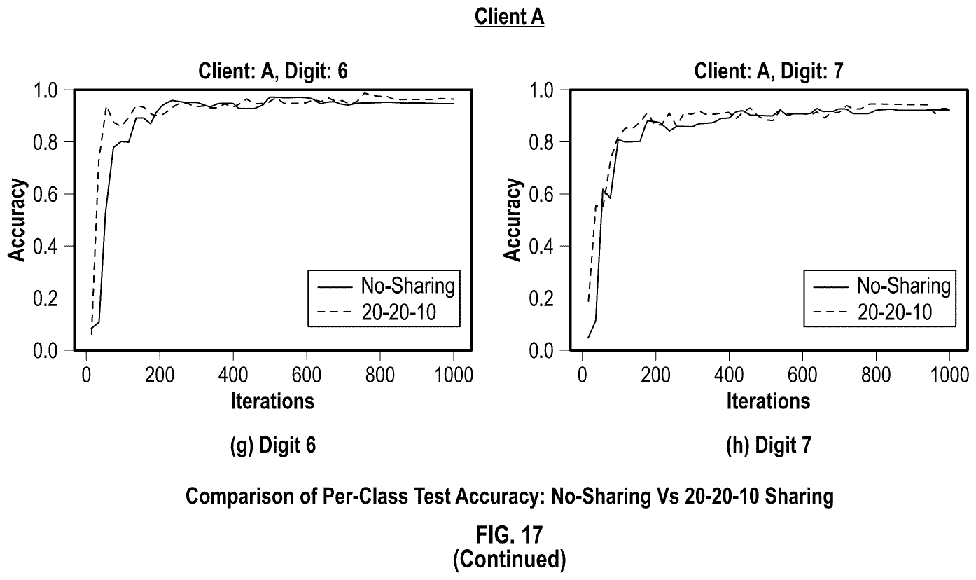

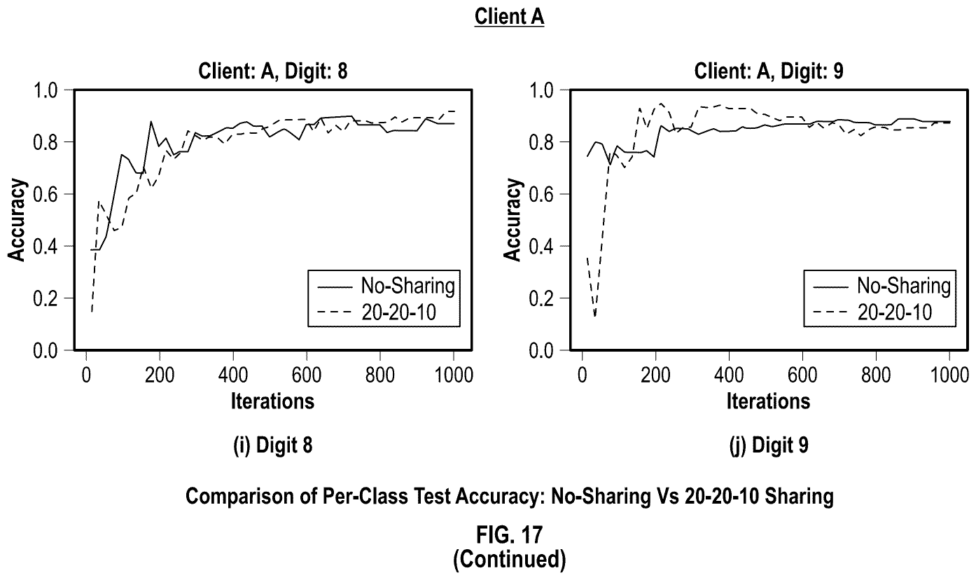

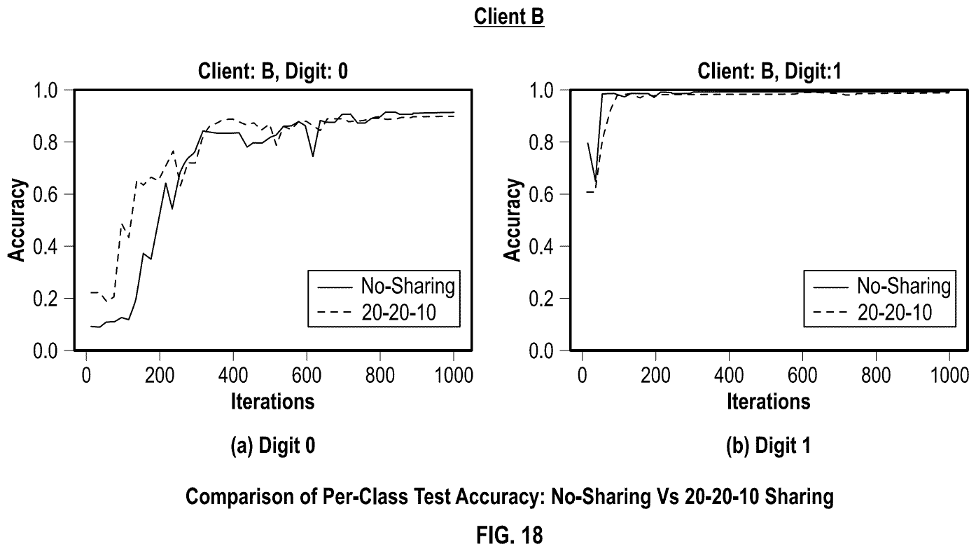

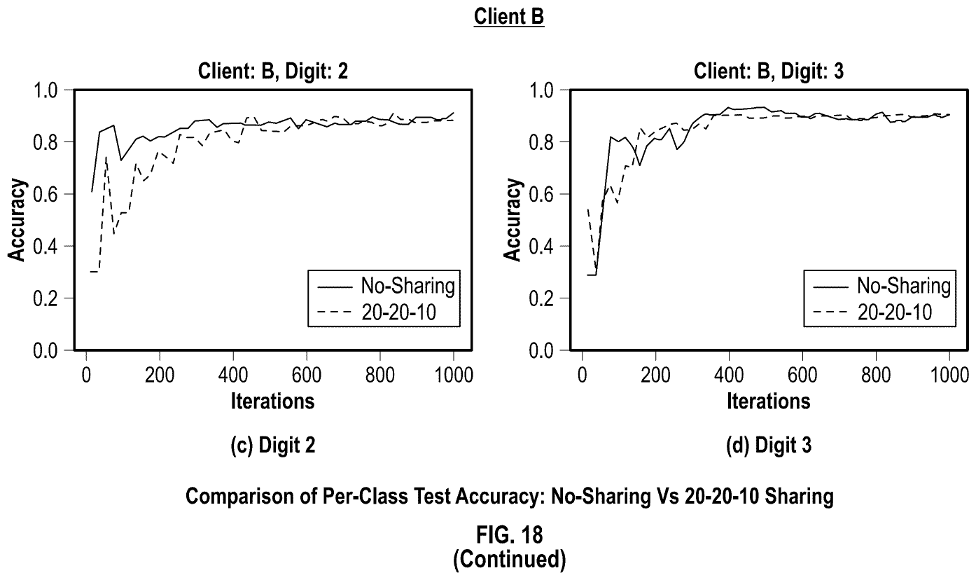

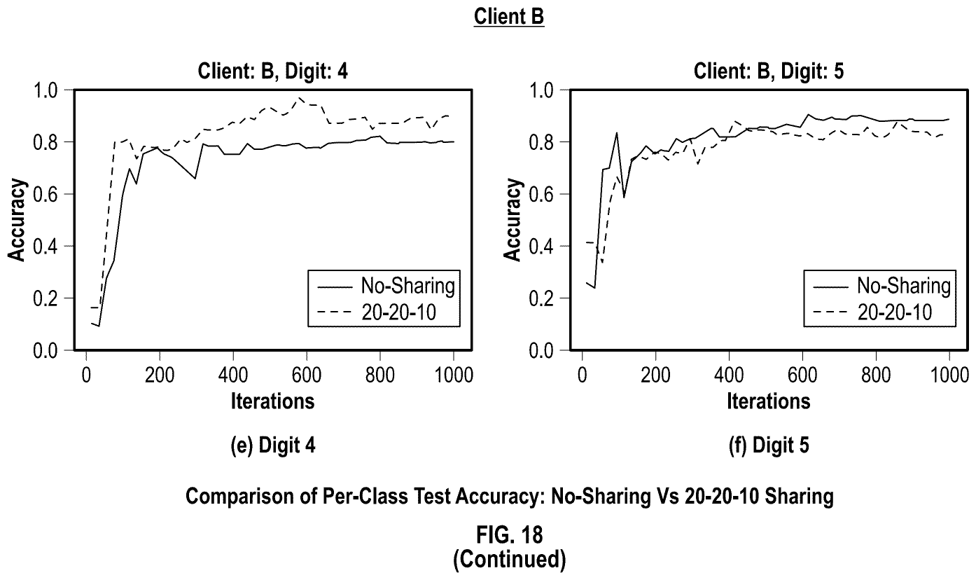

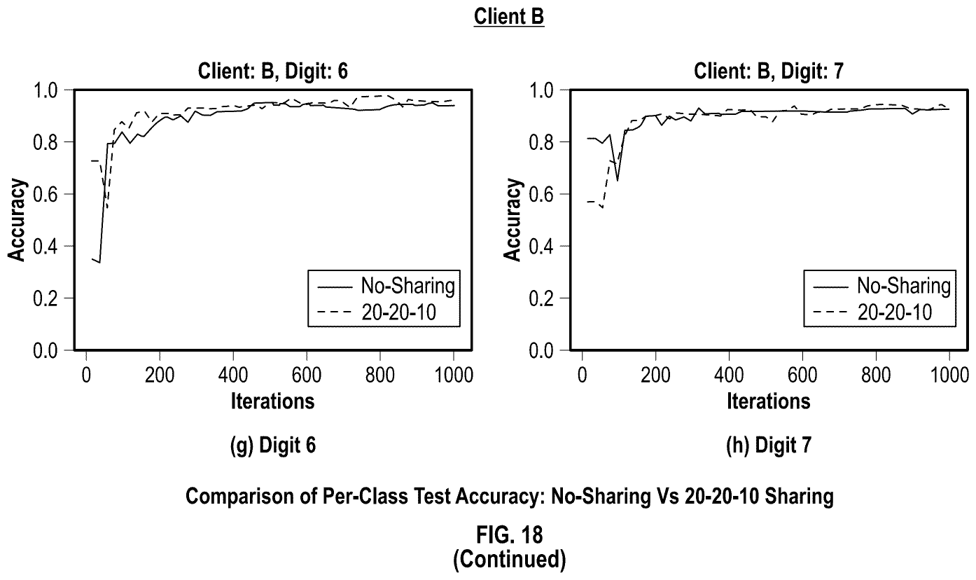

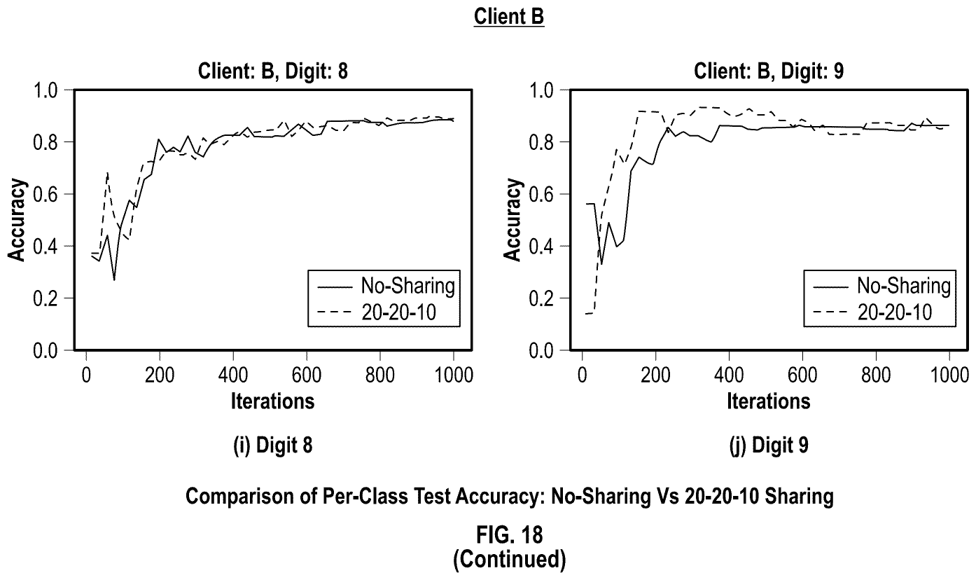

To examine the reason for a relatively smaller gain compared to vertically dis-data, we analyzed and compared the per-class test accuracy of both rations as shown in FIG. 17 and FIG. 18 for clients A and B respectively. As evident from all the plots in FIG. 17 and FIG. 18, despite a high disparity in the number of samples for different classes between both the clients, the testing accuracy for each class in both “sharing” and “no-sharing” configuration is similar. This phenomenon is explained by the simplicity of the MNIST dataset, where a model can trained with a low number of samples.

Communication Overhead

In this subsection, we provide an analysis of the communication overhead of our proposed approach. For a 2-client FL setting, consider an experiment configuration in which 40% of networks are shared in the first exchange (p=40), 40% of networks shared in the second exchange (q=40) and the exchange happens after every local generation (E=1). The total number of networks at each client is 960 (N=960). Although the size of the networks grows during the evolution process which is smaller than the size of the champion (final best-performing) network, we calculate the communication cost per exchange under the assumption that the clients always exchange networks of the same size as the champion network. Also, as evident from the experiments described herein, WFNAS is capable of performing well with lower values of p and q. However, this study will give us an approximation of the upper bound of communication overhead for a 2-client setting.

TABLE 5.8
Empirical Values of Attributes of the Champion Networks

| Attributes of the | | |
|---|---|---|
| champion network | Client A | Client B |
| # connections | 621 | 735 |
| # neurons | 419 | 449 |
| # hidden layers | 8 | 10 |
| Size (compressed) | 18 KB | 21 KB |

The networks are represented using an adjacency matrix, where the rows and the columns indicate the nodes having connections from and the nodes having connections to respectively. In Table 5.8, we present the experimentally obtained values of several attributes of the champion networks with both clients: number of connections, number of neurons, number of hidden layers, and compressed size. We use the compressed size of the networks because the number of connections in the champion networks are low and hence the adjacency matrices are very sparse.

During one exchange for the experiment configuration considered above, each client shares 768 networks

$$( \frac{( p + q ) * N}{100} ) .$$

The communication cost per exchange is 768×(18+21)=29.95 MB. Therefore, the overall communication overhead for G=2000 generations is 59.9 GB.

### CONCLUSION

In the present disclosure, we proposed a novel weight-agnostic federated NAS approach and performed extensive experiments to prove the efficacy of WFNAS. The networks produced by our proposed approach have several hundred connections all sharing one randomly chosen weight value as opposed to the state-of-the-art CNN networks (both handcrafted and automatically searched) having millions of parameters (each connection having a trainable weight-value) which may be infeasible for deployment on edge devices. Both horizontal and vertical FL settings were considered for experimentation with the MNIST dataset, and we demonstrated that while the approach compares favorably to standalone training with both FL settings, higher gains are observed for the vertical FL setting. To the best of our knowledge, this is also the first NAS contribution to the literature of vertical FL.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a processor in communication with a memory, the memory including instructions, which, when executed, cause the processor to:
initialize, at the processor, a plurality of minimally connected networks;
evaluate, at the processor, the plurality of minimally connected networks using a random sample from each respective class of a plurality of classes within a local dataset associated with a first client A;
facilitate, at the processor, a validation exchange between one or more minimally connected networks of the plurality of minimally connected networks of the first client A and one or more minimally connected networks of the plurality of minimally connected networks of a second client B;
assess, based on the validation exchange, a suitability of one or more minimally connected networks of the plurality of minimally connected networks of the first client A with respect to the second client B; and
select one or more minimally connected networks of the plurality of minimally connected networks of the first client A to share with the second client B.

2. The system of claim 1, wherein the memory further includes instructions, which, when executed, cause the processor to:
(1) apply, at the processor, a weight-agnostic network search methodology for current generation g of a plurality of generations G to a first plurality of minimally connected networks of the plurality of minimally connected networks using a random sample from each respective class of a plurality of classes within a local dataset associated with the first client A;
(2) facilitate, at the processor, a first validation exchange of the current generation g between a first percentage of the first plurality of minimally connected networks of the first client A and a first percentage of a second plurality of minimally connected networks of the plurality of minimally connected networks of a second client B;
(3) estimate, based on the first validation exchange, how one or more remaining networks of the first plurality of minimally connected networks would perform on a local dataset associated with the second client B using a trained estimator that incorporates a reward per class of the plurality of classes within the local dataset associated with the first client A as features for a regression model of the trained estimator;
(4) apply, at the processor, a per-class weighted averaging of rewards of the first plurality of minimally connected networks;
(5) facilitate, at the processor, a second validation exchange of the current generation g between a second percentage of the first plurality of minimally connected networks of the first client A and a second percentage of the second plurality of minimally connected networks of the second client B; and
(6) select a set of best-performing networks of the one or more minimally connected networks based on the second validation exchange.

3. The system of claim 2, wherein the memory further includes instructions, which, when executed, cause the processor to:
evolve, at the processor, the first plurality of minimally connected networks of the current generation g of the plurality of generations G;
evaluate the first plurality of minimally connected networks based on the random samples from each respective class of the local dataset of the first client A; and
average the evaluations of the first plurality of minimally connected networks over a first quantity of classes of the plurality of classes within the local dataset associated with the first client A.

4. The system of claim 2, wherein the memory further includes instructions, which, when executed, cause the processor to:
randomly select the first percentage p % of the first plurality of minimally connected networks in the current generation g (where p is a parameter for the first exchange);
evaluate the selected and the remaining networks of the first plurality of minimally connected networks on each respective class of the local data of the first client A;
send the selected minimally connected networks with associated per-class local reward evaluations to the second client B;
receive, from the second client B, a per-class reward evaluation of shared minimally connected networks of the first client A on the local dataset associated with the second client B;
receive, from the second client B, the first percentage p % of the second plurality of minimally connected networks associated with the second client B and their per-class rewards on the local dataset associated with the second client B;
evaluate the received networks of the second plurality of minimally connected networks from the second client B on the local data of the first client A;
send the per-class rewards back to the second client B;
train the trained estimator using the rewards per class as features for the regression model using the evaluation of shared networks on the local datasets associated with the first client A and the second client B;
estimate how the remaining networks of the would perform on the local data of the second client B; and
perform weighted averaging of rewards based on the number of samples per class with the first client A and the second client B.

5. The system of claim 4, wherein the memory further includes instructions, which, when executed, cause the processor to:
rank the first plurality of minimally connected networks based on the weighted rewards associated with the first client A and the second client B;
send the second percentage of q % minimally connected networks of the first plurality of minimally connected networks that have the highest ranked rewards to the second client B;
receive the second percentage of q % minimally connected networks of the second plurality of minimally connected networks that have the highest ranked rewards from the second client B;
rank the pool of networks including the first plurality of minimally connected networks of the first client A and the second percentage of q % minimally connected networks of the second plurality of minimally connected networks of the second client B;
select N best-performing networks for the next generation g+1 of the plurality of generations G; and
increase g by one increment.

6. The system of claim 2, wherein the memory further includes instructions, which, when executed, cause the processor to:
iteratively repeat steps (1)-(6) at each generation g of the plurality of generations G.

7. The system of claim 2, wherein the memory further includes instructions, which, when executed, cause the processor to:
apply, at the processor, a weight-agnostic network search methodology for current generation g of a plurality of generations G to the second plurality of minimally connected networks using a random sample from each respective class of a plurality of classes within the local dataset associated with the second client B;
facilitate, at the processor, the first validation exchange of the current generation g between a first percentage of the second plurality of minimally connected networks of the second client B and a first percentage of the first plurality of minimally connected networks of the first client A;
estimate, based on the first validation exchange, how one or more remaining networks of the second plurality of minimally connected networks would perform on a local dataset associated with the first client A using a trained estimator that incorporates a reward per class of the plurality of classes within the local dataset associated with the second client B as features for a regression model of the trained estimator;
apply, at the processor, a per-class weighted averaging of rewards of the second plurality of minimally connected networks; and
facilitate, at the processor, the second validation exchange of the current generation g between the second percentage of the second plurality of minimally connected networks of the second client B and a second percentage of the first plurality of minimally connected networks of the first client A.

8. The system of claim 1, wherein the memory further includes instructions, which, when executed, cause the processor to:
assign, at the processor, a category to a minimally connected network of the plurality of minimally connected networks associated with the first client A or the second client B based on one or more characteristics of the minimally connected network; and
select, at the processor, one or more minimally connected networks of the plurality of minimally connected networks from one or more categories to send to the second client B or the first client A.
